(19) United States
(12) Patent Application Publication
(10) Pub. No.: US 2023/0187643 A1
(43) Pub. Date: Jun. 15, 2023

(54) BINDER, COMPOSITION FOR MANUFACTURING DRY ELECTRODE, DRY ELECTRODE, AND METHOD OF MANUFACTURING DRY ELECTRODE

(71) Applicants: HYUNDAI MOTOR COMPANY, Seoul (KR); Kia Corporation, Seoul (KR)

(72) Inventors: Hyunjin KIM, Daegu (KR); Hannah SONG, Ansan-si (KR); Sangwook HAN, Ansan-si (KR); Geun Ho CHOI, Cheongju-si (KR)

(73) Assignees: HYUNDAI MOTOR COMPANY, Seoul (KR); Kia Corporation, Seoul (KR)

(21) Appl. No.: 17/993,453

(22) Filed: Nov. 23, 2022

(30) Foreign Application Priority Data
Dec. 9, 2021 (KR) 10-2021-0175335

(51) Int. Cl. H01M 4/62; H01M 4/04

(52) U.S. Cl. CPC H01M 4/623; H01M 4/043; H01M 2004/021

(57) ABSTRACT

The present embodiments relate to a binder, a composition for manufacturing a dry electrode comprising the same, and a method for manufacturing a dry electrode. In one embodiment, as secondary particles comprising at least one first particle, the binder may be separated from the secondary particles into the at least one first particle when stirred with a dispersion equipment.

### CROSS-REFERENCE TO RELATED APPLICATION

This application claims priority to and the benefit of Korean Patent Application No. 10-2021-0175335 filed in the Korean Intellectual Property Office on Dec. 9, 2021, the entire contents of which are incorporated herein by reference.

### TECHNICAL FIELD

The present disclosure relates to an electrochemical device, and more particularly, to a binder, a composition for manufacturing a dry electrode, a dry electrode, and a method for manufacturing a dry electrode.

### BACKGROUND

As interest in energy storage technology increases, research and development in fields requiring energy storage, such as mobile phones, laptop, and electric vehicles, are being actively conducted. In particular, in the electrochemical device, along with the development of a rechargeable battery capable of charging and discharging, there is an active movement for the development of a new electrode for improving the capacity density and specific energy of the secondary battery.

As interest in the electrochemical device increases, research for lowering the resistance, increasing the high-capacity, and improving the mechanical properties or productivity of the electrochemical device is in progress, so a manufacturing method with high productivity in manufacturing the electrochemical device is required. As an electrode used in an electrochemical device, particularly conventional looking at the conventional film forming process, the bulk active material and the non-fibrillable binder are mixed, the active material and the binder are mixed, a composition may be prepared by mixing the mixed active material with the binder in high shear. The prepared composition may be mixed with the bulk active material and the non-fibrillable binder to obtain an electrode by low shear jet milling and calendering. The manufacturing method of the electrode has a problem in that it takes a lot of time and cost to produce the electrode, because it has to go through a lot of process steps, so that mass productivity is poor.

The above information disclosed in this Background section is only for enhancement of understanding of the background of the disclosure, and therefore it may contain information that does not form the prior art that is already known in this country to a person of ordinary skill in the art.

### SUMMARY

The present disclosure has been made in an effort to provide a binder, a composition for manufacturing a dry electrode, a dry electrode, and a method for manufacturing a dry electrode having advantages of simplifying an electrode manufacturing process, preventing a lot of cost and time consuming, and maximizing mass productivity when generating an electrode. An exemplary embodiment of the present disclosure provides a binder. Another embodiment of the present disclosure provides a composition for manufacturing a dry electrode. Yet another embodiment of the present disclosure provides a dry electrode. According to an embodiment of the present disclosure provides a method for manufacturing a dry electrode.

The technical object to be solved by the present disclosure is to provide a binder capable of simplifying an electrode manufacturing process, preventing a lot of cost and time consuming, and maximizing mass productivity when generating an electrode.

Another technical object to be solved by the present disclosure is to provide a composition for manufacturing an electrode comprising a binder having the above-described advantages.

Another technical object to be solved by the present disclosure is to provide a dry electrode comprising a composition for manufacturing an electrode having the above-described advantages.

Another technical object to be solved by the present disclosure is to provide a method for manufacturing a dry electrode having the above-described advantages.

According to an exemplary embodiment of the present disclosure, the binder is a binder in the form of secondary particles comprising at least one first particle, the binder may be separated from the secondary particles into the at least one first particle when the binder is stirred with a dispersing equipment. In an exemplary embodiment, when a stirring speed of about 20 m/s to 40 m/s may be applied to the binder, the secondary particles are separated from the at least one first particle.

In exemplary embodiment, when a stirring speed of about 20 m/s to 35 m/s may be applied to the binder, the secondary particles are separated from the at least one first particle. In an exemplary embodiment, an average particle diameter (D50) of the first particles may be about 600 nm or less. In an exemplary embodiment, an average particle diameter (D50) of the secondary particles may be about 50 to 900 μm or less. In an exemplary embodiment, the secondary particles may be at least one of polytetrafluoroethylene (PTFE) orpolyvinylidene fluoride (PVDF).

A composition for manufacturing a dry electrode according to another exemplary embodiment may comprise about 0.01 to 5% by weight of a binder in the form of secondary particles comprising at least one first particle in 100% by weight of the composition for manufacturing a dry electrode, wherein the binder is separated from the secondary particles into the at least one first particle when the binder is stirred with a dispersing equipment.

In some embodiments, when a stirring speed of about 20 m/s to 40 m/s is applied to the binder, the secondary particles are separated from the at least one first particle.

In some embodiments, when a stirring speed of about 20 m/s to 35 m/s is applied to the binder, the secondary particles are separated from the at least one first particle.

In some embodiments, an average particle diameter (D50) of the at least one first particle is about 600 nm or less and an average particle diameter (D50) of the secondary particles is about 50 to 900 μm or less.

A method for manufacturing a dry electrode according to another exemplary embodiment of the present disclosure, may comprise preparing an electrode composition comprising an active material and a conductive material and a binder;

mixing about 90 to 99 wt % of electrode composition, about 0.01 to 5 wt % of binder, and the remainder of the conductive material, 0.01 to 5 wt %; and

pressing the mixed mixture; in the mixing, the electrode composition, the binder, and the remainder of the conductive material may be stirred with a dispersion equipment, the binder in the form of secondary particles comprising at least one first particle may be separated from the secondary particles into the at least one first particle. In exemplary embodiment, when stirring with the dispersion equipment, a stirring speed of about 20 to 40 m/s may be applied.

In exemplary embodiment, the preparing further comprises: preparing a binder in the form of the at least one first particle, and preparing the binder in the form of the at least one first particle as the binder in the form of the secondary particles may be comprised in the step of preparing the binder. In an exemplary embodiment, the mixing may further comprise determining whether a degree of dispersion of the binder based on an average particle diameter of the at least one first particle.

In an exemplary embodiment, the mixing may be performed at a mixing temperature in the range of about 10 to 100° C. In an exemplary embodiment, the mixing may further comprise controlling a heat generated in the mixing the active material, the conductive material, and the binder.

In an exemplary embodiment, the mixing may be performed at a time in the range of about 1 to 60 minutes. In an exemplary embodiment, the pressing may be performed in the range of about 15 to 200° C.

In an exemplary embodiment, attaching the dry electrode manufactured in the step of manufacturing the dry electrode and the current collector may be further comprised after the step of mixing. In an exemplary embodiment, in the step of attaching the dry electrode and the current collector, at least one of temperature and pressure may be applied to the dry electrode and the current collector.

In an exemplary embodiment of the present disclosure, it comprises a binder comprising first particles and secondary particles assembled from a plurality of the first particles, characterized in that the shear force applied to the binder is in a range between the binder's own energy and the plastic deformation energy of the binder, by mixing the active material, the conductive material, and the binder at once to simplify the process, a composition for manufacturing a dry electrode can be easily obtained.

In another embodiment of the present disclosure, a composition for manufacturing an electrode having the above advantages may be provided.

In another exemplary embodiment of the present disclosure, a dry electrode manufacturing method having the above advantages may be provided

### BRIEF DESCRIPTION OF THE DRAWINGS

FIG. 1 illustrates a binder, according to an exemplary embodiment of the present disclosure.

FIG. 2 shows a tissue photograph of a composition for manufacturing a dry electrode, according to an exemplary embodiment of the present disclosure.

FIG. 3 shows a dry electrode, according to an exemplary embodiment of the present disclosure.

FIG. 4 is a flowchart of a method for manufacturing a dry electrode, according to an exemplary embodiment of the present disclosure.

FIG. 5A to FIG. 5C schematically illustrate a dry electrode manufacturing process, according to an exemplary embodiment of the present disclosure.

FIG. 6A and FIG. 6B are SEM photographs of first particles and secondary particles of a binder, according to an exemplary embodiment of the present disclosure.

FIG. 7A and FIG. 7B are SEM photographs of first particles and secondary particles of a binder, according to a comparative example of the present disclosure.

FIG. 8A to FIG. 8D show SEM images of a binder, according to an exemplary embodiment of the present disclosure.

FIG. 9A to FIG. 9D show SEM images of a binder, according to an exemplary embodiment of the present disclosure.

FIG. 10A to FIG. 10D show SEM images of a binder, according to an embodiment of the present disclosure.

FIG. 11A to FIG. 11D show SEM images of a binder, according to an exemplary embodiment of the present disclosure.

### DETAILED DESCRIPTION OF THE EMBODIMENTS

The terms first, second and third etc. are used to describe, but are not limited to, various parts, components, regions, layers and/or sections. These terms are used only to distinguish one part, component, region, layer or section from another part, component, region, layer or section. Accordingly, a first part, component, region, layer or section described below may be referred to as a second part, component, region, layer or section without departing from the scope of the present disclosure.

The terminology used herein is for the purpose of referring to specific exemplary embodiments only, and is not intended to limit the present disclosure. As used herein, the singular forms also comprise the plural forms unless the phrases clearly indicate the opposite. As used herein specification, the meaning of “comprising” specifies a particular characteristic, region, integer, step, operation, element, and/or component, and does not exclude the presence or addition of another characteristic, region, integer, step, operation, element and/or component.

When a part is referred to as being “above” or “on” another part, it may be directly on or on the other part, or the other part may be involved in between. In contrast, when a part refers to being “directly above” another part, the other part is not interposed therebetween.

Although not defined otherwise, all terms comprising technical terms and scientific terms used herein have the same meaning as those commonly understood by a person of an ordinary skill in the art to which the present disclosure belongs. Commonly used terms defined in the dictionary are additionally interpreted as having a meaning consistent with the related technical literature and the presently disclosed content, and unless defined, are not interpreted in an ideal or very formal meaning.

Hereinafter, an exemplary embodiment of the present disclosure will be described in detail. However, this is provided as an example, and the present disclosure is not limited thereto, and the present disclosure is only defined by the range of the claims to be described later.

FIG. 1 shows a binder (BD), according to an exemplary embodiment.

Referring to FIG. 1, in exemplary embodiment, the binder (BD) may be in the form of secondary particles (SP) comprising at least one first particle FP. The binder (BD) may be a component that assists bonding between the active material and the conductive material and adhesion to the current collector. The binder (BD) may be a non-acryl-based polymer or an acryl-based polymer. In an exemplary embodiment, the binder (BD) composed of the first particles (FP) and the secondary particles (SP) may be, specifically, polytetrafluoroethylene (PTFE) and polyvinylidene fluoride (PVDF). In exemplary embodiment, the binder (BD) may comprise first particles (FP) and secondary particles (SP) assembled from a plurality of first particles (FP).

In an exemplary embodiment, when a stirring speed of about 20 m/s to 40 m/s is applied, the binder (BD) may be separated from the secondary particles (SP) into the first particles (FP). Specifically, when a stirring speed of about 20 to 30 m/s is applied, the binder (BD) may be separated from the secondary particles (SP) into the first particles (FP) without plastic deformation. The stirring speed is the stirring linear speed, and in the speed range, the binder (BD) is separated from the secondary particles (SP) into the first particles (FP), and in particular, without plastic deformation of the particles such as the first particles being crushed, secondary particles (SP) may be separated into first particles (FP)

When out of the lower limit of the range, the secondary particles (SP) are maintained without separation into the first particles (FP) as an energy range lower than the binder's own energy, and when out of the upper limit of the range, the binder plastic deformation may occur in a range of energy levels higher than its own energy. For example, when the speed range is expressed as the number of rotations per unit, it may correspond to a range of about 2,548 rpm to 3,822 rpm.

In an exemplary embodiment, when a stirring speed of about 20 m/s to 40 m/s is applied to the binder (BD), both the first particles (FP) and the secondary particles (SP) may be separated. For example, the binder (BD) is added to the stirrer, and when the stirring speed is applied, the stirring speed, specifically the stirring linear speed, in the range, in the binder (BD), both the first particles (FP) and the secondary particles (SP) are separated, and plastic deformation in which the shape of the first particles (FP) is crushed may occur. For example, when the speed range is expressed as the number of rotations per unit, it may correspond to a range of about 3,850 rpm to 6,000 rpm. Accordingly, when a stirring speed in the range of about 20 to 40 m/s, specifically about 20 to 30 m/s, is applied, the binder (BD) may have an excellent degree of dispersion without plastic deformation.

In an exemplary embodiment, the shear force applied to the binder (BD) may be greater than or greater than the energy value of the binder (BD) and smaller than the plastic deformation energy value of the binder (BD). In exemplary embodiment, the binder (BD) may be mixed with electrode compositions, for example, electrode compositions such as an active material and a conductive material to be described later, and in the process of mixing, the speed, specifically, the range of the stirring linear speed shear force may be applied. Within the linear velocity range, the secondary particles (SP) of the binder (BD) are separated into the first particles (FP), and may be appropriately mixed and dispersed with the electrode compositions.

As the binder (BD) decomposes in the above speed range, the binder (BD) does not need to undergo an additional pulverization process when mixed with the electrode composition, thereby simplifying the process, thereby increasing the mass productivity of the dry electrode, it is possible to obtain a dry electrode having excellent conductivity by suppressing agglomeration between electrode compositions.

Since the secondary particles (SP) composed of a plurality of first particles (FP) are easily decomposed into first particles (FP), the secondary particles (SP) are converted into first particles (FP) through one mixing and grinding process and evenly dispersed in the electrode material, so that an electrode may be formed in a single process without the need for a separate additional shearing process.

In an exemplary embodiment, the first particles (FP) of the binder (BD) may have a D50 of 600 nm or less, specifically 500 nm or less, and the secondary particles (SP) have a D50 of about 50 to 900 μm, specifically it may range from about 100 to 800 μm. When the first particles (FP) of the binder (BD) are larger than the above range, dispersion is not good, and there is a problem in manufacturing a dry electrode. When the secondary particles (SP) are larger than the above range, there is a problem in that dispersion is difficult and a larger energy range is required.

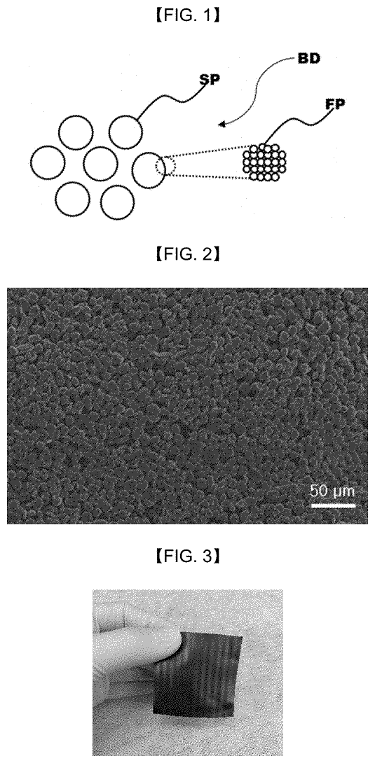

FIG. 2 illustrates a composition for manufacturing a dry electrode, according to an exemplary embodiment.

Referring to FIG. 2, the composition for manufacturing a dry electrode may comprise a binder (BD). The composition for manufacturing a dry electrode may comprise an active material, which is an electrode material, and a conductive material mixed with the electrode. The description of the binder (BD) is the same to the extent that it does not contradict that described in FIG. 1. The active material is a component of the composition for manufacturing a dry electrode, and may be a positive electrode active material when the dry electrode is a positive electrode, and may be a negative electrode active material when a negative electrode is a negative electrode. The positive electrode is one selected from the group consisting of LiCoO₂, LiNiO₂, LiNiₓMn_{y}O₂, Li_{1-z}NiₓMn_{y}Co_{1-x-y}O₂, LiNiₓCo_{y}Al_{z}O₂, LiV₂O₅, LiTiS₂, LiMoS₂, LiMnO₂, LiCrO₂, LiMn₂O₄, LiFeO₂, LiFePO₄, and combinations thereof, wherein x is 0.3 to 0.8, y is 0.1 to 0.45, and z may independently be 0 to 0.2. The positive electrode may be more specifically LiFePO₄, LiCoO₂, NCM811, and NCM622.

The negative electrode is natural graphite, artificial graphite (mesophase carbon microbead), pyrolytic carbon, liquid crystal pitch based carbon fiber, liquid crystal pitch (mesophase pitches), petroleum and coal-based coke (petroleum or carbonaceous materials such as coal tar pitch derived cokes); lithium-containing titanium composite oxide (LTO), Si, Sn, Li, Zn, Mg, Cd, Ce, Ni, or Fe metals (Me); alloys composed of the above metals; oxides of the above metals (MeOₓ), and the metals (Me) and carbon composites, and combinations thereof. Specifically, the negative electrode may be natural graphite particles, synthetic graphite particles, Sn particles, Li₄Ti₅O₁₂ particles, Si particles, Si—C composite particles, and combination thereof. More specifically, the negative electrode may be natural graphite, artificial graphite, silicon, or a combination thereof.

The conductive material may comprise a material having conductivity without causing a chemical change in the electrode. The conductive material may comprise carbon black, such as carbon black, acetylene black, Ketjen black, channel black, farness black, lamp black, thermal black, conductive fiber such as carbon fiber or metal fiber, metal powder such as aluminum or nickel powder, zinc oxide, it may be a conductive whisker such as potassium carbonate, a conductive metal oxide such as titanium oxide, or a conductive material such as a polyphenylene derivative. Specifically, the conductive material may be a conductive carbon material.

In one embodiment, the composition for manufacturing a dry electrode may comprise about 0.01-5 wt % of the binder (BD) in 100 wt % of the composition for manufacturing a dry electrode. Specifically, it may comprise 90-99 wt % of the active material, about 0.01-5 wt % by weight of the conductive material, and about 0.01-5% by weight of the binder (BD). When the content of the conductive material is 0.01-5 wt %, the electron transport ability and energy density of the active material may be increased, and when the content of the binder (BD) is about 0.01-5 wt %, the adhesion between the dry electrode and the current collector to be described later this is improved, by improving adhesion, electrode resistance may be reduced or electrode detachment may be prevented even after cell degradation, and ion conductivity or electrical conductivity within the electrode may be improved by suppressing the movement of the binder (BD) to the electrode surface.

FIG. 3 shows a dry electrode, according to an exemplary embodiment.

Referring to FIG. 3, the dry electrode may be manufactured by using the composition for preparing a dry electrode comprising the binder (BD) described above in FIG. 1 to FIG. 2. The dry electrode may be attached to at least one surface of a current collector to be used in a battery, and then may be used as a battery for a secondary battery of an electronic device, for example, a mobile phone or a vehicle.

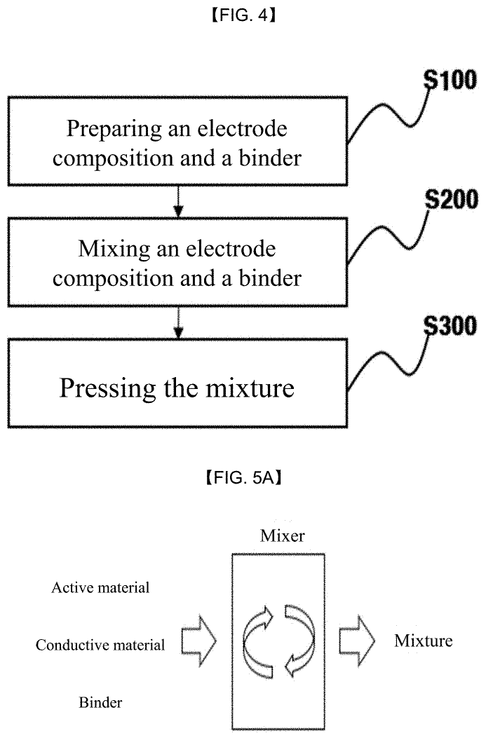

FIG. 4 is a flowchart of a method for manufacturing a dry electrode, according to an exemplary embodiment.

Referring to FIG. 4, the dry electrode manufacturing method comprises the steps of preparing an electrode composition and a binder (BD) (S100), mixing the electrode composition and the binder (BD) (S200), and pressing the mixed mixture (S300) may be comprised. In the dry electrode manufacturing method, the step (S100) of preparing the electrode composition and the binder (BD) is an electrode composition, for example, an active material and a conductive material may be prepared. A binder (BD) that is evenly dispersed in the electrode composition may be prepared. The active material and the conductive material are non-limiting examples, and a general active material and conductive material may be prepared.

In the step (S100) of preparing the electrode composition and the binder (BD), the step of preparing the binder (BD) in the form of first particles (FP) and the binder (BD) in the form of first particles (FP) as secondary particles (SP) may comprise a step of preparing the form. The first particle (FP) may be defined as a minimum unit particle constituting the binder (BD), and the first particle (FP) may have an average particle diameter (D50) within about 500 nm.

In the step of preparing the binder (BD) in the form of first particles (FP) in the form of secondary particles (SP), a plurality of first particles (FP) may be assembled to prepare the binder (BD) in the form of secondary particles (SP). The secondary particle (SP) may be defined as particles in which a plurality of first particle (FP) are gathered and aggregated, and the secondary particle (SP) may have an average particle diameter (D50) of about 100 to 800 μm.

In this way, the binder (BD) is formed into secondary particles, and in the pulverization process described later, as the binder (BD) in the form of secondary particle (SP) is pulverized into particles of first particle (FP), there is an advantage in excellent dispersibility compared to using a binder in the form of first particles in the prior art.

The shear force applied to the binder (BD) may be greater than or equal to the energy of the binder (BD) itself, and may be less than the plastic deformation energy of the binder (BD). Detailed descriptions of the shear force, the self-energy of the binder (BD), and the plastic deformation energy of the binder BD may refer to FIG. 1 and FIG. 2.

In the step (S200) of mixing the electrode composition and the binder (BD), the electrode composition, for example, an active material and a conductive material, and the binder (BD) may be mixed. Specifically, about 90-99 wt % of the active material, about 0.01-5 wt % of the binder (BD), and about 0.01-5 wt % of the conductive material may be mixed. The active material may be one of a positive active material or a negative active material, and the description of the active material, the conductive material, and the binder (BD) may refer to FIG. 1 to FIG. 3 to the extent not contradictory.

In the mixing step, a stirring speed of about 15 to 40 m/s may be applied. In the mixing step, the active material, the conductive material, and the binder (BD) are put in a mixing device, for example, a mixer or a stirrer, and a shear force is applied to the active material, the conductive material, and the binder (BD) may be mixed.

In one embodiment, in the mixing step, a stirring speed in the range of about 15 to 40 m/s, specifically, about 15 to 35 m/s may be applied. In the above range, specifically, at a stirring speed in the range of 15 to 35 m/s, the binder (BD) may be separated from the secondary particle (SP) into the first particle (FP), a detailed description thereof is the same as long as it does not contradict the aforementioned FIG. 1 and FIG. 2.

In an exemplary embodiment, the mixing may be performed at a mixing temperature in the range of about 10 to 100° C. In an exemplary embodiment, the mixing may comprise a mixing process for about 8 to 12 minutes, specifically 9 to 11 minutes.

In exemplary embodiment, the mixing may further comprise controlling a heat generated in the process of mixing. The step of controlling a heat may control heat generated in the step of applying the shear force. A thermal control device, for example a cooler, may be comprised for thermal control. The step of controlling a heat comprises the active material, the conductive material, and the binder (BD) at about 25 m/s, specifically about 20 m/s or less, in the mixer, for example, the composition for manufacturing a dry electrode may be prepared by mixing at a stirring speed of a stirrer, and cooling the heat generated in the process of mixing to 2 about 5° C., specifically, to about 20° C. or less.

In an exemplary embodiment, the mixing may further comprise determining whether the dispersion of the binder (BD) is good in the dry electrode manufacturing method. When the degree of dispersion of the binder (BD) is good, manufacturing may be performed as a dry electrode, and when the degree of dispersion of the binder (BD) is not good, return to the binder (BD) selection step (S100) again and the binder (BD) may be reselected. The degree of dispersion of the binder BD may be determined through, for example, a scanning electron microscope (SEM). Through the SEM photograph, it is possible to determine whether the binder (BD) is agglomerated. Determination of whether the binder (BD) is agglomerated may be determined that dispersion is not performed when the length of the shortest part of the area of the agglomerated region of the binder (BD) exceeds about 2 μm. This is a non-limiting example, and it is clear that it is possible to determine whether the binder (BD) is agglomerated by various methods.

In the step of pressing the mixed mixture (S300), a dry electrode manufacturing composition having a good dispersion degree of the binder is put into a pressurizing device to manufacture a dry electrode. The pressing device is a device for applying at least one of temperature and pressure to the composition, and may be, for example, a pressing device or a calendaring device.

In an exemplary embodiment, the pressurizing device may adjust at least one of a pressure, a temperature, a film forming rate, and a dry electrode density. In the case of the pressure, about 1 ton to 120 ton, specifically about 1 ton to 100 ton, in the case of the temperature, about 15° C. to 200° C., specifically about 20° C. to 180° C., and the film forming speed, about 1 m/min to 25 m/min, specifically about 1 m/min to 20 m/min.

In an exemplary embodiment, the manufactured dry electrode density may be about 1 g/cm³ to 25 g/cm³, specifically, about 1 g/cm³ to 20 g/cm³. It is clear that the dry electrode density may be different depending on the type of electrode material. In an exemplary embodiment, the dry electrode may be a self-supporting dry electrode.

In an exemplary embodiment, the dry electrode manufacturing method may further comprise a pressing step of applying pressure to the manufactured dry electrode. By the pressing step, the thickness of the dry electrode may be adjusted.

In an exemplary embodiment, the method may further comprise attaching the manufactured dry electrode and the current collector. The step of attaching the prepared dry electrode and the current collector may be a process of attaching the dry electrode to the current collector in order to use the prepared dry electrode in a battery. The dry electrode may be attached to at least one surface of the current collector. The process of attaching the dry electrode to the current collector may be, for example, a lamination process. In an exemplary embodiment, the current collector may use aluminum foil when the dry electrode is a positive electrode material, and copper foil when the negative electrode material is used.

In an exemplary embodiment, the step of attaching the dry electrode and the current collector is about 1 ton to 120 ton, specifically about 1 ton to 100 ton, in the case of pressure, about 15° C. to 210° C., specifically about 20° C. to 200° C., and in the case of the roll speed, it may be about 1 m/min to 60 m/min, specifically about 1 m/min to 50 m/min. By comprising the step of attaching the dry electrode and the current collector, it is possible to manufacture a battery in which the dry electrode is attached to the current collector.

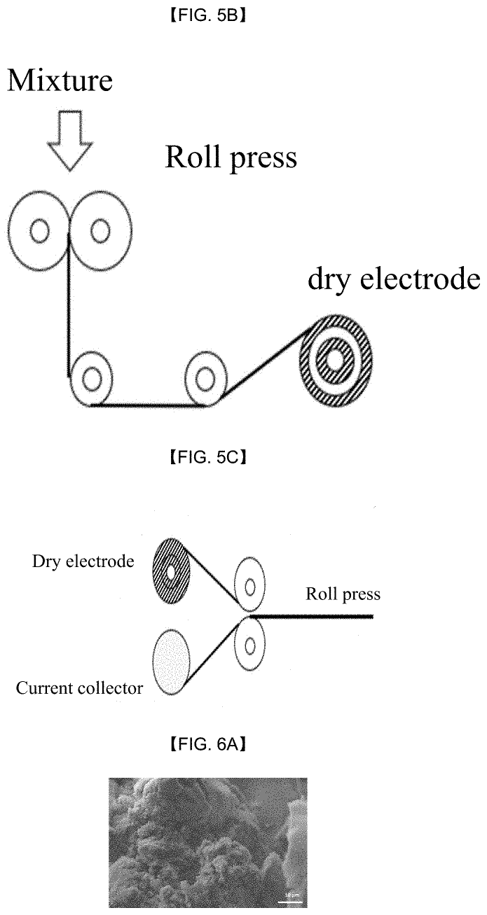

As described above, according to an exemplary embodiment of the present disclosure, by manufacturing the dry electrode, the active material, the conductive material, and the binder (BD) are mixed at once to simplify the process, so that the composition for manufacturing the dry electrode may be easily obtained, thereby reducing the process time and by reducing the cost, it is possible to increase the mass productivity when manufacturing the dry electrode. FIG. 5A to referring to FIG. 5C, an overall process of a dry electrode manufacturing process according to an exemplary embodiment of the present disclosure may be confirmed.

FIG. 5A to FIG. 5C schematically illustrate a dry electrode manufacturing process, according to an exemplary embodiment. An embodiment of the present disclosure will be described below with reference to FIG. 5A to FIG. 5C. The following examples are only examples of the present disclosure, and the present disclosure is not limited to the following examples.

### Examples and Comparative Examples

### (1) The Method for Manufacturing a Dry Electrode Comprises the Step of Preparing an Electrode Composition and a Binder

The binder (BD) of the present disclosure may be evenly dispersed in an electrode composition such as an active material and a conductive material. When the binder (BD) is applied at a stirring speed of the stirrer in the range of about 20 m/s (2548 rpm) to 30 m/s (3822 rpm), it may be separated from secondary particles into first particle, and the binder (BD), when a stirring speed in the range of about 30 m/s (3822 rpm) to 38 m/s (5096 rpm) is applied, plastic deformation in which both the first particles and the secondary particle are separated may occur.

FIG. 6A and FIG. 6B are SEM photographs of first particles and secondary particles of a binder, according to an embodiment.

FIG. 6A and referring to FIG. 6B, SEM photographs of primary and secondary particle according to an exemplary embodiment of the present disclosure are shown. FIG. 6A shows first particles having an average particle diameter (D50) of about 500 nm or less according to an embodiment of the present disclosure. FIG. 6B is a secondary particle having a D50 of about 50 to 900 μm according to an exemplary embodiment of the present disclosure, in which the first particles are relatively less aggregated, and it may be seen that the surface of the secondary particles is rough.

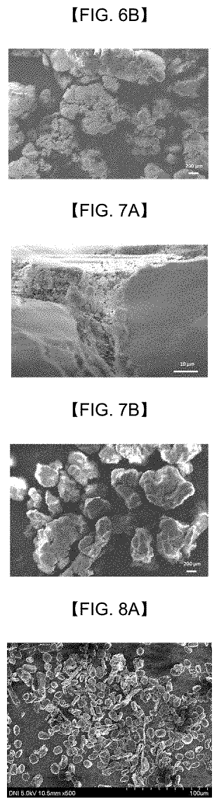

FIG. 7A and FIG. 7B is a first particle and secondary particle SEM photograph of a binder, according to Comparative Example of the present disclosure.

Referring to FIG. 7A and FIG. 7B, they show SEM pictures of first particles and secondary particles according to Comparative Example. FIG. 7A shows first particles having an average particle diameter D50 of about 500 nm or less according to Comparative Example of the present disclosure. FIG. 7B is a secondary particle having a D50 of about 50 to 900 μm according to Comparative Example of the present disclosure, in which the first particles are strongly aggregated, and the surface of the secondary particles shows a smooth shape, so more energy is required to disperse it. Therefore, according to an exemplary embodiment of the present disclosure, as a binder (BD), Polytetrafluoroethylene (PTFE) was used. In the exemplary embodiment 1, during the extrusion process in the binder manufacturing process, the extrusion ratio (Reduction Ratio) was carried out as about 20-1600:1. It may be confirmed that the binder in the form of secondary particles is separated into first particles with only one mixing using the binder.

### (2) The Step of Mixing the Electrode Composition and the Binder

The binder (BD) selected from (1) is simultaneously put into the active material and conductive material, specifically, the conductive carbon material and the mixer. about 90 to 99 wt % of the active material, about 0.01 to 5 wt % of the conductive material, and about 0.01 to 5 wt % of the binder (BD) are mixed at a speed of about 20 to 30 m/s for 9 to about 11 minutes. In this case, as the mixer, a high shear mixer of EIRICH's Laboratory Mixer EL10 Profi Plus was used as a stirrer. The chamber diameter of the stirrer is about 36 cm, the chamber height of the stirrer is 26 cm, and the diameter of the stirrer rotor is about 18 cm.

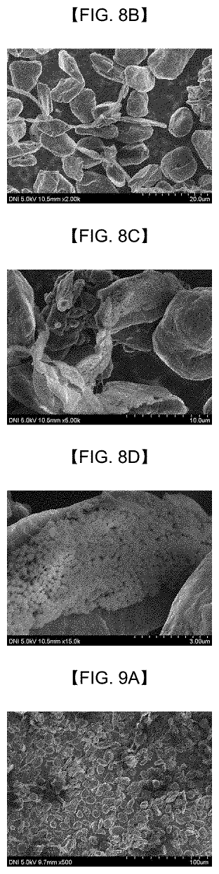

FIG. 8A to FIG. 8D shows an SEM photograph of a binder, according to an exemplary embodiment.

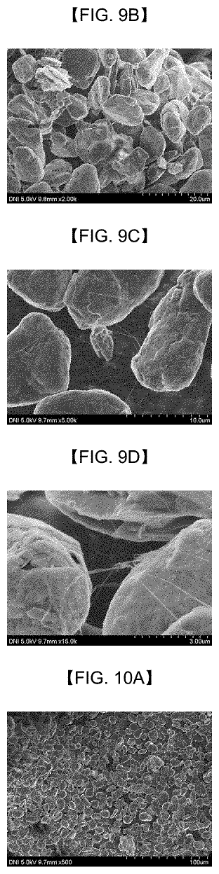

FIG. 8A to FIG. 8D show the binder according to the SEM photographic magnification when the stirring speed applied to the binder is in the range of about 1 m/s (127 rpm) to 20 m/s (2548 rpm). FIG. 8A shows a magnification of 500, FIG. 8B shows a magnification of 2k, FIG. 8C shows a magnification of 5k, and FIG. 8D shows a magnification of 15 k. This will be described later in FIG. 9A to FIG. 11D may be equally applied to each.

Referring again to FIGS. 8A to 8B, it may be seen that the secondary particles are not dispersed into the first particles and the first particles are aggregated as they are while the secondary particles are elongated by the force of the mixer.

FIG. 9A to FIG. 9D shows an SEM photograph of a binder, according to an exemplary embodiment.

FIG. 9A to FIG. 9D show the binder according to the SEM photographic magnification when the stirring speed applied to the binder is in the range of about 20 m/s (2548 rpm) to 30 m/s (3822 rpm).

Referring again to FIGS. 9A to 9D, it may be seen that the binder is not plastically deformed and has become fibrous like a thread that is dispersed between graphite particles in the form of first particles. Accordingly, in the binder of the present disclosure in the range, secondary particles are separated into first particles, but it may be confirmed that the first particles are not decomposed and plastically deformed, so that the binder's own energy range may be determined.

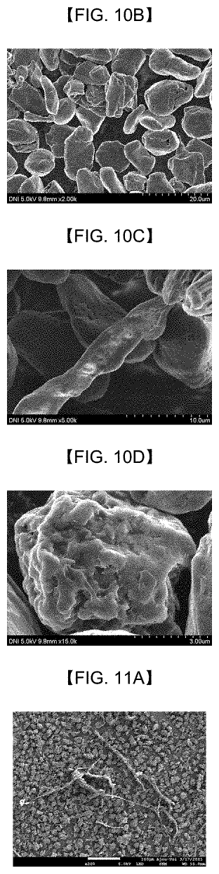

FIG. 10A to FIG. 10D shows an SEM photograph of a binder, according to an exemplary embodiment.

FIG. 10A to 10D show the binder according to the SEM photographic magnification when the stirring speed applied to the binder is in the range of about 30 m/s (3822 rpm) to 38 m/s (5096 rpm).

Referring again to FIGS. 10A to 10D, it may be determined that the shape of the first particles of the binder is broken. Accordingly, it may be confirmed that plastic deformation occurs in the binder of the present disclosure within the above range. Therefore, for the binder of the present disclosure, it may be confirmed that the stirring speed should be applied in the speed range of about 20 m/s (2548 rpm) to 30 m/s (3822 rpm) to separate from secondary particles into first particles at the same time without plastic deformation.

### (3) The Step of Determining Whether the Dispersion of the Binder is Good

In order to determine whether the dispersion of the composition prepared in (2) is good, it is possible to check the dispersion of the binder with a mixer. If the binder is not well dispersed, the binder may be reselected by returning to (1). If the binder is well dispersed, step (4) may be performed. The step of determining whether the dispersion is good may be determined based on the SEM photograph of the composition, as shown in the following table. Specifically, the determination may be made based on the SEM photos shown in FIGS. 7A to 7C. In the step of determining whether the dispersion is good, if the length of the shortest part of the area of the region where only the binder is aggregated in the SEM photograph exceeds about 2 μm, it is determined that the dispersion is not possible, when it did not exceed 2 μm, it was judged that dispersion was favorable. If the dispersion is good as shown in FIG. 7b, proceed to step (4).

### (4) The Step of Pressing the Mixed Mixture

Dry electrode may be manufactured by putting the composition for dry electrode manufacturing that has undergone (3) steps into roll press equipment. The roll press may be operated at a pressure in the range of about 1 ton to 100 ton and at a speed of 1 m/min, specifically, may be operated at a pressure of about 1 ton to 40 ton and a pressure of about 1 m/min to 20 m/min. After the roll press, the prepared dry electrode may be a dry electrode of a self-supporting film. The density of the dry electrode may have a value between about 1 g/cm³ and 20 g/cm³.

### (5) The Step of Attaching the Dry Electrode and the Current Collector

Through the process (4), the manufactured dry electrode may be attached to the current collector. In order to attach the dry electrode to at least one surface of the current collector, a lamination process may be performed. For the lamination process, the dry electrode manufactured by step 4, specifically, a self-supporting dry electrode and a current collector may be put together and roll pressed. When the current collector is a positive electrode material, an aluminum foil may be used, and in the negative electrode material, a copper foil may be used. The lamination process may be performed at a roll speed of about 1 m/min to 50 m/min by applying a roll press pressure in the range of about 1 ton to 100 ton. In addition, in the lamination process, a temperature of about 200° C. or less may be applied to the roll press to improve adhesion between the dry electrode and the current collector.

### COMPARATIVE EXAMPLE

In step (1), except for the average particle size is different in that the average particle size D50 is 600 μm, and in the extrusion process during the binder manufacturing process, the exemplary embodiment 1 is about 20-1600:1, whereas the comparative example is about 30-300:1, it was carried out in the same manner as in exemplary embodiment 1.

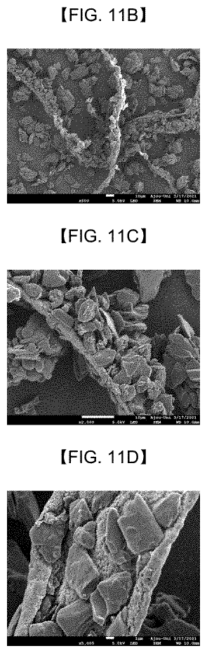

FIG. 11a to FIG. 11d show SEM photos of the binder when the comparative example was tested in the range of about 20 m/s (2548 rpm) to 30 m/s (3822 rpm), which is the same range as in Example 1.

FIG. 11a to FIG. 11d, it may be seen that the binder is not decomposed and the electrode material is attached to the binder itself. Accordingly, the binder may not be decomposed even if higher energy is applied to decompose the binder into first particles, and when high energy is applied, the high temperature of the generated mixer may cause damage to the electrode material. is judged not to be suitable.

The present disclosure is not limited to the exemplary embodiments, but may be manufactured in a variety of different forms, and a person of an ordinary skill in the technical field to which the present disclosure belongs is without changing the technical idea or essential features of the present disclosure. It will be understood that the disclosure may be embodied in other specific forms. Therefore, it should be understood that the exemplary embodiments described above are exemplary in all respects and not restrictive.

While this disclosure has been described in connection with what is presently considered to be practical exemplary embodiments, it is to be understood that the disclosure is not limited to the disclosed embodiments. On the contrary, it is intended to cover various modifications and equivalent arrangements comprised within the spirit and scope of the appended claims.

Unless otherwise specified, all numbers, values, and/or expressions expressing quantities of ingredients, reaction conditions, polymer compositions, and formulations used herein contain all numbers, values and/or expressions in which such numbers essentially occur in obtaining such values, among others. Since they are approximations reflecting various uncertainties in the measurement, it should be understood as being modified by the term “about” in all cases. As used herein, the term “about” means modifying, for example, lengths, degrees of errors, dimensions, the quantity of an ingredient in a composition, concentrations, volumes, process temperature, process time, yields, flow rates, pressures, and like values, and ranges thereof, refers to variation in the numerical quantity that may occur, for example, through typical measuring and handling procedures used for making compounds, compositions, concentrates or use formulations; through inadvertent error in these procedures; through differences in the manufacture, source, or purity of starting materials or ingredients used to carry out the methods; and like considerations. The term “about” also encompasses amounts that differ due to aging of, for example, a composition, formulation, or cell culture with a particular initial concentration or mixture, and amounts that differ due to mixing or processing a composition or formulation with a particular initial concentration or mixture. Whether modified by the term “about” the claims appended hereto include equivalents to these quantities. The term “about” further may refer to a range of values that are similar to the stated reference value. In certain embodiments, the term “about” refers to a range of values that fall within 10, 9, 8, 7, 6, 5, 4, 3, 2, 1 percent above or below the numerical value (except where such number would exceed 100% of a possible value or go below 0%) or a plus/minus manufacturing/measurement tolerance of the numerical value.

What is claimed is:

1. A binder in the form of secondary particles comprising at least one first particle, wherein
the binder is separated from the secondary particles into the at least one first particle when the binder is stirred with a dispersing equipment.

2. The binder of claim 1, wherein
when a stirring speed of about 20 m/s to 40 m/s is applied to the binder, the secondary particles are separated from the at least one first particle.

3. The binder of claim 1, wherein
when a stirring speed of about 20 m/s to 35 m/s is applied to the binder, the secondary particles are separated from the at least one first particle.

4. The binder of claim 1, wherein
an average particle diameter (D50) of the at least one first particle is about 600 nm or less.

5. The binder of claim 1, wherein
an average particle diameter (D50) of the secondary particles is about 50 to 900 μm or less.

6. The binder of claim 1, wherein
the secondary particles are at least one of polytetrafluoroethylene (PTFE) or polyvinylidene fluoride (PVDF).

7. A composition for manufacturing a dry electrode comprising about 0.01 to 5% by weight of a binder in the form of secondary particles comprising at least one first particle in 100% by weight of the composition for manufacturing a dry electrode, wherein the binder is separated from the secondary particles into the at least one first particle when the binder is stirred with a dispersing equipment.

8. A method for manufacturing a dry electrode, comprising:
preparing an electrode composition comprising an active material and a conductive material and a binder;
mixing about 90 to 99 wt % of electrode composition, about 0.01 to 5 wt % of the binder, and the remainder of the conductive material, 0.01 to 5 wt %; and
pressing the mixed mixture;
in the step of mixing, the electrode composition, the binder, and the remainder of the conductive material are stirred with a dispersion equipment,
the binder in the form of secondary particles comprising at least one first particle is separated from the secondary particles into the at least one first particle.

9. The method of claim 8, wherein,
when stirring with the dispersion equipment,
a stirring speed of about 20 to 40 m/s is applied.

10. The method of claim 8, the preparing comprising
preparing a binder in the form of the at least one first particle, and preparing the binder in the form of at least one first particle as the binder in the form of the secondary particles.

11. The method of claim 8, wherein
the step of mixing further comprises:
determining a degree of dispersion of the binder based on an average particle diameter of the at least one first particle.

12. The method of claim 8, wherein
the step of mixing is performed at a mixing temperature in the range of about 10 to 100° C.

13. The method of claim 8, wherein
the step of mixing further comprises:
controlling a heat generated in a process of mixing the active material, the conductive material, and the binder.

14. The method of claim 8, wherein
the step of mixing is performed at a time in the range of 1 to 60 minutes.

15. The method of claim 8, wherein
the step of pressing is performed in the range of about 15 to 200° C.

16. The method of claim 8, further comprising:
attaching a dry electrode manufactured in the step of manufacturing the dry electrode and a current collector after the step of mixing.

17. The method of claim 16, wherein
in the step of attaching the dry electrode and the current collector, at least one of temperature and pressure is applied to the dry electrode and the current collector.

18. The composition of claim 7, wherein when a stirring speed of about 20 m/s to 40 m/s is applied to the binder, the secondary particles are separated from the at least one first particle.

19. The composition of claim 7, wherein when a stirring speed of about 20 m/s to 35 m/s is applied to the binder, the secondary particles are separated from the at least one first particle.

20. The composition of claim 7, wherein:
an average particle diameter (D50) of the at least one first particle is about 600 nm or less and an average particle diameter (D50) of the secondary particles is about 50 to 900 μm or less.
